(19) United States
(12) Patent Application Publication
(10) Pub. No.: US 2025/0216573 A1
(43) Pub. Date: Jul. 3, 2025

(54) METHOD FOR EXTRACTING FEATURES WITH SHARP SPATIAL VARIATIONS IN GEOPHYSICAL MODELS

(71) Applicant: CHINA PETROLEUM & CHEMICAL CORPORATION, Beijing (CN)

(72) Inventor: Huimin GUAN, Houston, TX (US)

(21) Appl. No.: 19/005,019

(22) Filed: Dec. 30, 2024

Related U.S. Application Data
(60) Provisional application No. 63/615,861, filed on Dec. 29, 2023.

(51) Int. Cl. G01V 1/36; G06T 7/13

(52) U.S. Cl. CPC G01V 1/364; G06T 7/13; G01V 2210/642; G06T 2207/20182

(57) ABSTRACT

In seismic data, migration images and inverted models, interesting structures with sharp spatial variations such as faults, channels or caves are embedded in laterally smooth stratigraphic layers, coherent and non-coherent noises etc. One way to enhance these structures is to take advantage of the local strong contrast property and use Sobel filter. However, Sobel filter is a discrete differentiation operator which enhances the edges and may lead to drastic amplitude changes within one feature and add difficulties to interpretation. The method uses histogram equalization after Sobel filter which makes the amplitude of a feature much more homogenous and presents a much clearer image of faults or channels with little background noise.

### CROSS-REFERENCE TO RELATED APPLICATION

This application claims priority to U.S. Provisional Patent Application having Ser. No. 63/615,861, filed on Dec. 29, 2023, the content of which is incorporated herein by reference in its entirety.

### TECHNICAL FIELD

This application relates generally to oil and gas exploration, more particularly relates to method for producing high quality geophysical models.

### BACKGROUND

Many image processing tools can be used on seismic images to enhance interesting features embedded in seismic data, migration images and inverted models. Sobel filter is a discrete differentiation operator computing an approximation of the gradient of the data presented in an image. So, features such as faults and channels in seismic images, which have strong local contrast are pushed out by applying Sobel filter. While smoothly changing background has small derivative values. After placing thresholds, background images with small values can be excluded and only those interesting features with sharp spatial changes are left. However, one event may appear as two or more because the derivatives of a feature in seismic data may have a big range. Hence, we bring in histogram equalization to combine image sections from one feature into one integrated image.

A histogram is an approximate representation of the distribution of numerical data. Histograms give a rough sense of the density of the underlying distribution of the data and often for estimating the (PDF—the probability of a random variable falling within a particular range of values of unit length) of the underlying variable. Histogram equalization (HE) is a method to process images to adjust the contrast of an image. It accomplishes this by making the cumulative distribution function (CDF) of the image linear. It is implemented as a transform to map values of current image to their corresponding CDF values. After placing thresholds most values in the resulted image are zeros, so the PDF of value zero is close to 1 while that of all the other values are close to zero. This leads to the CDF of all non-zero values are close to 1 except that of zero is zero. To avoid the derivatives of one feature to be zero, light smoothing is applied to the image after thresholding. Applying histogram equalization to the resulted image may generate a clean picture of the interesting features we would like to enhance, which can be used to aid interpretation or just for presentation purposes.

### SUMMARY

A workflow is proposed to extract interesting structures with sharp spatial variations in seismic data, migration images and inverted models, such as faults, channels or caves etc. The procedure combines the Sobel filter and histogram equalization (HE), which generates a clean image of structures with strong local contrast and can be used to aid interpretation and for presentation. A simple synthetic example is presented to illustrate the effectiveness of the approach.

### BRIEF DESCRIPTION OF DRAWINGS

FIG. 1 shows an image of an exemplary seismic model having a strong contrast is embedded in smoothly changing background.

FIG. 2A shows the exemplary seismic model after applying the Sobel filter.

FIG. 2B shows the model in FIG. 2A after applying thresholds.

FIG. 2C illustrates the PDF to the model in FIG. 2B.

FIG. 2D illustrates the CDF of the model in FIG. 2B.

FIG. 3 presents the result of histogram equalization.

FIG. 4 illustrates a workflow of the method for optimizing the geophysical model.

### DETAILED DESCRIPTION OF EMBODIMENTS

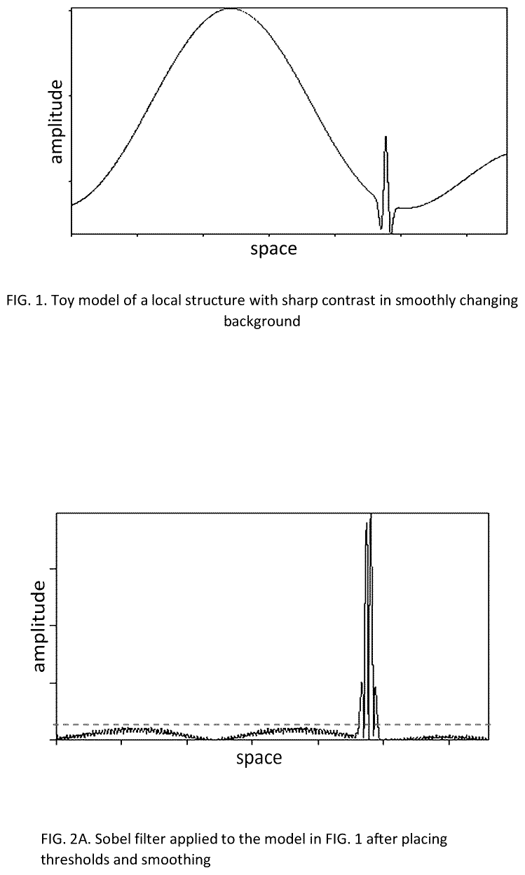

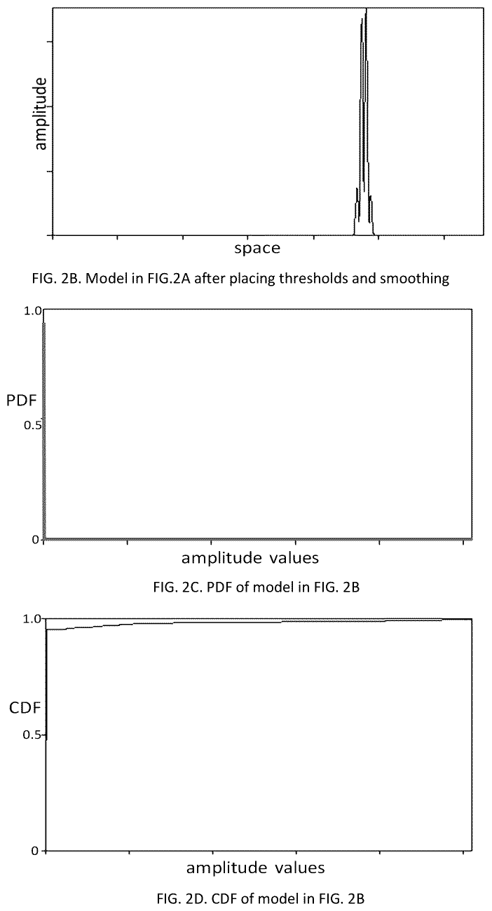

FIG. 1 shows an image of a simple seismic model, in which a local structure with strong contrast is embedded in smoothly changing background. To extract this local structure out, we apply the Sobel filter, the result of which is shown in FIG. 2A. The spatial derivatives of the slowly changing features are small while those of the structure with strong contrast are big, therefore the local structure becomes much more prominent as shown in FIG. 2B. But the amplitude of the local structure zigzags rapidly, which makes the feature appear as more than one event. After placing thresholds indicated by the blue dotted line in FIG. 2A and applying light smoothing, the model is shown in FIG. 2B. The histogram (PDF) of the model is presented in FIG. 2C, in which the histogram of value zero is very big while that of other values are very small close to zero, because most values in the image are zeroes. This leads to the CDF of the image shown in FIG. 2C. Other than the value zero, the CDF of all other values are very close and close to value 1.

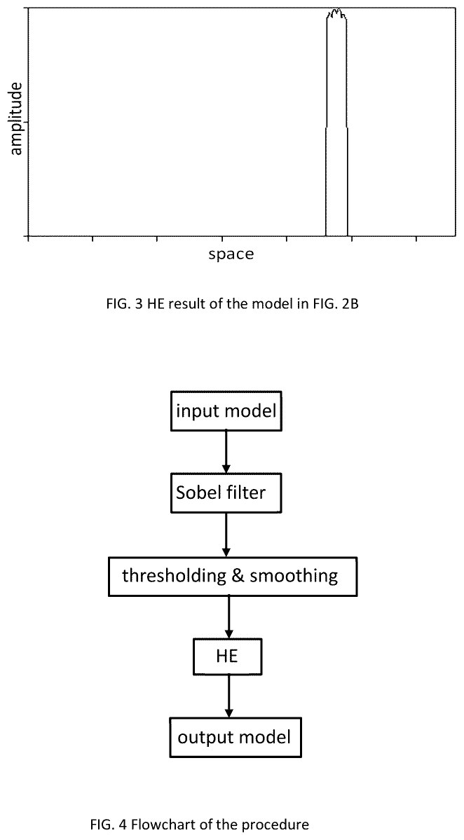

FIG. 3 is the result after histogram equalization. Although the values of the image of the local structure in FIG. 2B change drastically, the CDF values of which are close, so the image in FIG. 3 is clear and appears as one integrated feature.

We claim:

1. A method for extracting a feature with sharp spatial variations from seismic information, comprising: apply Sobel filter to the seismic information; applying a threshold to the filtered information; smoothing the information after thresholding; and applying histogram equalization to the smoothed data.

2. The method of claim 1, wherein the seismic information is seismic data, migration images, or inverted models.

3. The method of claim 1, wherein the feature is a faults, a channel, or a caves.
